(19) United States
(12) Patent Application Publication
(10) Pub. No.: US 2018/0266454 A1
(43) Pub. Date: Sep. 20, 2018

(54) Clamping Hub

(71) Applicant: MISUMI USA, Inc., Schaumburg, IL (US)

(72) Inventors: Joseph Borucki, Schaumburg, IL (US); Chester L. Millstead, JR., Schaumburg, IL (US)

(21) Appl. No.: 15/918,219

(22) Filed: Mar. 12, 2018

Related U.S. Application Data
(60) Provisional application No. 62/471,136, filed on Mar. 14, 2017.

(51) Int. Cl. F16B 2/06

(52) U.S. Cl. CPC F16B 2/065

(57) ABSTRACT

According to an aspect, a clamping hub includes a body connected to a clamping collar via a neck, there the clamping collar extends outward from the body. The clamping hub also includes a central bore running through the body and the clamping collar and configured for receiving a shaft. The clamping collar is configured to substantially surround and clamp to the shaft. The clamping collar is divided into first and second collar segments along a chord of the central bore that is offset from the center of the central bore towards the first collar segment. The second collar segment is tapped for a clamping screw that passes through the first collar segment and threadedly engages the second collar segment.

### TECHNICAL FIELD

The present invention generally relates to hubs for rotating shafts, and particularly relates to clamping hubs.

### SUMMARY

Embodiments of the present invention provide for clamping hubs with a more effective clamping ability.

According to some embodiments, a clamping hub includes a body connected to a clamping collar via a neck, where the clamping collar extends outward from the body. The clamping hub also includes a central bore running through the body and the clamping collar and configured for receiving a shaft. The clamping collar is configured to substantially surround and clamp to the shaft. The clamping collar is divided into first and second collar segments along a chord of the central bore that is offset from the center of the central bore towards the first collar segment. The second collar segment is tapped for a clamping screw that passes through the first collar segment and threadedly engages the second collar segment.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 is a perspective view of a clamping hub, according to an example embodiment.

FIG. 2 is a diagram of central bore of a clamping hub, illustrating a chord of the central bore that is offset from the center line of the central bore.

FIG. 3 is a diagram of a side view of the hub.

FIG. 4 is a cross-sectional view of the hub.

FIG. 5 is a side view of the hub, annotated with example dimensions.

FIG. 6 is a top view of the hub, annotated with example dimensions.

FIG. 7 is an end view of another embodiment of a hub.

### DETAILED DESCRIPTION

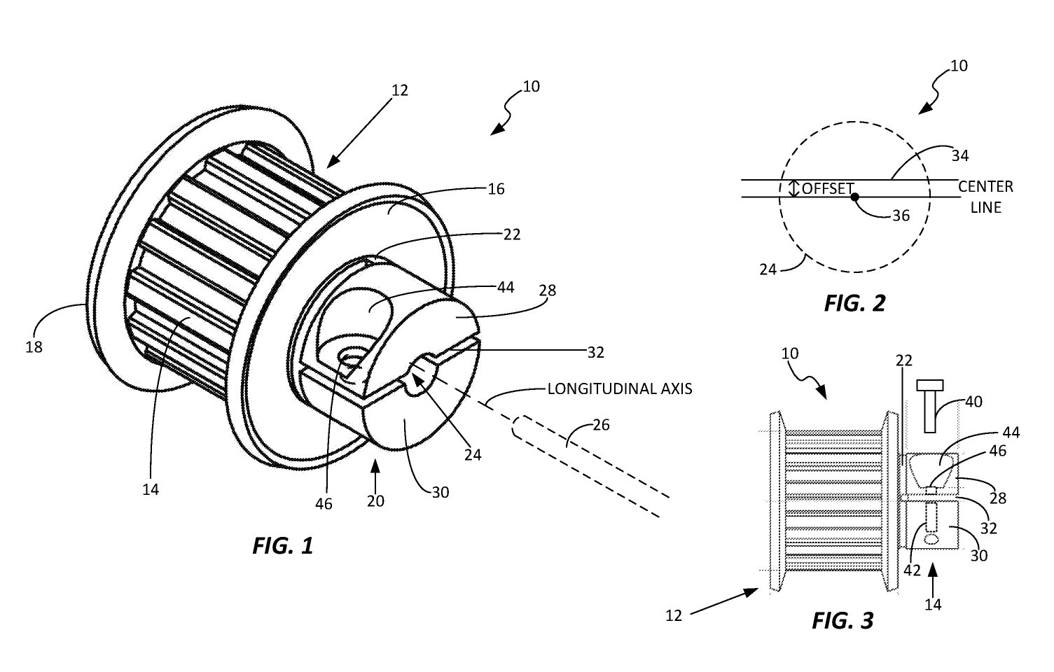

FIG. 1 illustrates a clamping hub 10 in an example embodiment. The term “hub” should be given broad construction and means essentially any member or body configured for mounting on a rotating shaft. Thus, while the body 12 of the hub 10 shown in FIG. 1 is configured for engaging with a belt or web, the body 12 may include radially extending teeth along its circumference, e.g., for use as a sprocket or gear.

In the depicted example, the central portion 14 of the body 12 is ribbed and bounded by opposing sides 16 and 18, which may have a larger circumference than the central portion 14, e.g., for better belt retention. The hub 10 further includes a clamping collar 20 that is connected to the body 12 via a neck 22 and extends outward from the body 12. The clamping collar 20 may be integrally formed with the body 12, where the neck 22 is formed by cutting away all but a portion of the material joining the clamping collar 20 to the body 12.

A central bore 24 runs through the body 12 and the clamping collar 20, such that the clamping collar 20 is considered to extend outward from the body 12 along the longitudinal axis of the central bore 24. The central bore 24 is configured for receiving a shaft 26, e.g., a driven shaft. The clamping collar 20 is configured to substantially surround and clamp to the shaft 26 and is divided—i.e., split—into first and second collar segments 28 and 30 by a separating cut or defined gap 32 that extends from the terminal end or face of the clamping collar 20 back along the longitudinal axis of the central bore 24 towards the body 12. The depth of the cut or gap 32 extends, for example, back to the neck 22 joining the clamping collar 20 to the body 12.

In turn, the neck 22 may be formed by a cut or gap formed or made at the base of the clamping collar 20 where it joins with the body 12—i.e., at the face of the side 16 from which the damping collar 20 extends outward. The cut or gap to form the neck 22 runs orthogonal to the longitudinal axis of the central bore 24 and, in an example configuration, has a depth going from the outer diameter of the clamping collar and extending through the central bore 24. One sees that the cut or gap by which the neck 22 is formed leaves the first and second collar segments 28 and 30 “floating” or cantilevered with respect to the body 12, which allows for the clamping action.

As shown in FIG. 2, the division of the first and second collar segments 28 and 30 is offset from the center 36 of the central bore 24. That is, the separating gap 32 that defines the division between the first and second collar segments 28 and 30 runs along a chord 34 of the central bore 24, with the chord 34 being offset from the center 36 of the central bore 24 and extends along the secant corresponding to the chord 34. In the diagram, the offset is towards the first collar segment 28, leaving relatively more material in the second collar segment 30.

The second collar segment 30 is tapped for a clamping screw 40 that passes through the first collar segment 28 and threadedly engages the second collar segment 30. For example, the first collar segment 28 includes a machined or formed opening 44 for clearing the screw head. As shown in FIG. 3, the opening 44 reduces down to a smooth bore 46 extending downward in alignment with a threaded bore 42 in the second collar segment 30.

The partial separation between the clamping collar 20 and the body 12, as provided by the neck 22, allows some movement of the first and second collar segments 28 and 30 towards each other as the damping screw 40 is tightened. That is, tightening the screw 40 draws the first and second collar segments 28 and 30 together—the gap 32 closes as the screw tightens. Thus, tightening the clamping screw 40 causes the clamping hub 10 to clamp tightly around the shaft 26.

Among its other advantages, offsetting the gap 32 that splits the damping collar 20 into the first and second collar segments 28 and 30 provides greater depth in the second collar segment 30—a longer threaded bore—for engaging the clamping screw 40. In turn, the greater thread engagement allows greater torqueing values to be used for drawing the two collar segments 28 and 30 together when clamping around the shaft 26. In other words, the enhanced thread engagement allows higher torqueing of the clamping screw 40, which provides greater clamping force. The greater clamping force prevents slipping between the hub 10 and the shaft 26, thereby allowing the hub 10 to transmit higher torque values than would be possible with a centerline division of the collar segments 28 and 30.

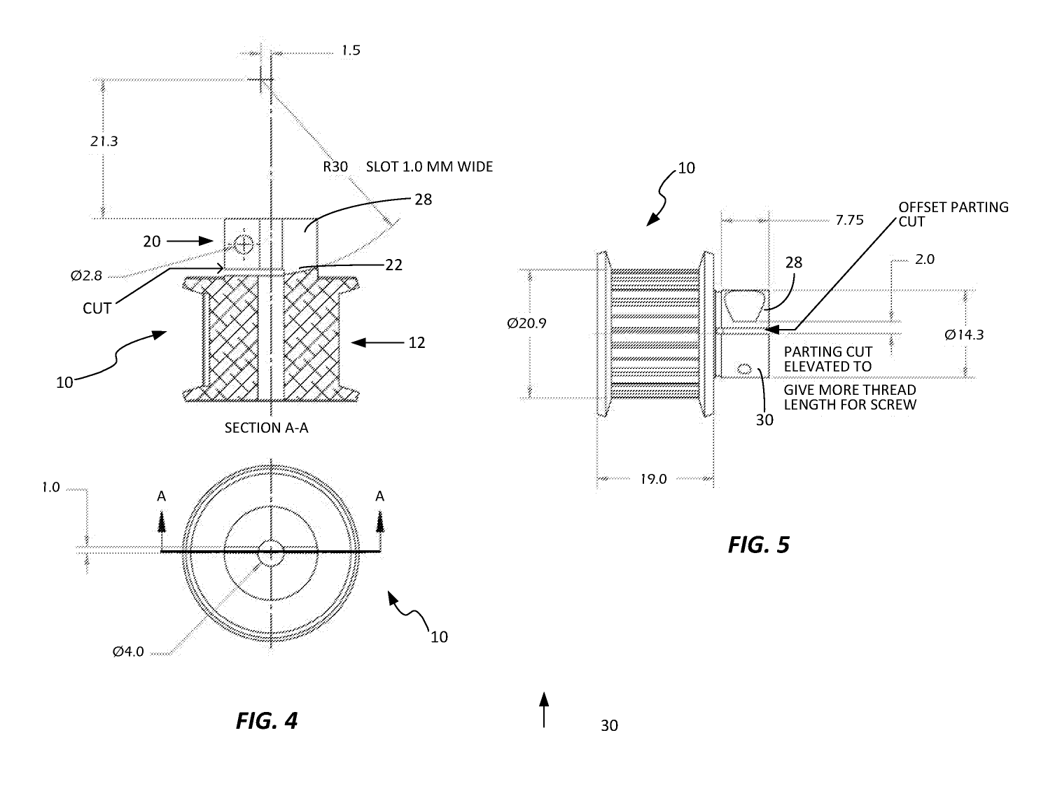

FIG. 4 illustrates a cross-section of the body 12 of the hub 10. FIG. 4 provides a good view of the neck 22, which joins the first and second collar segments 28 and 30 of the clamping collar 20 to the body 12.

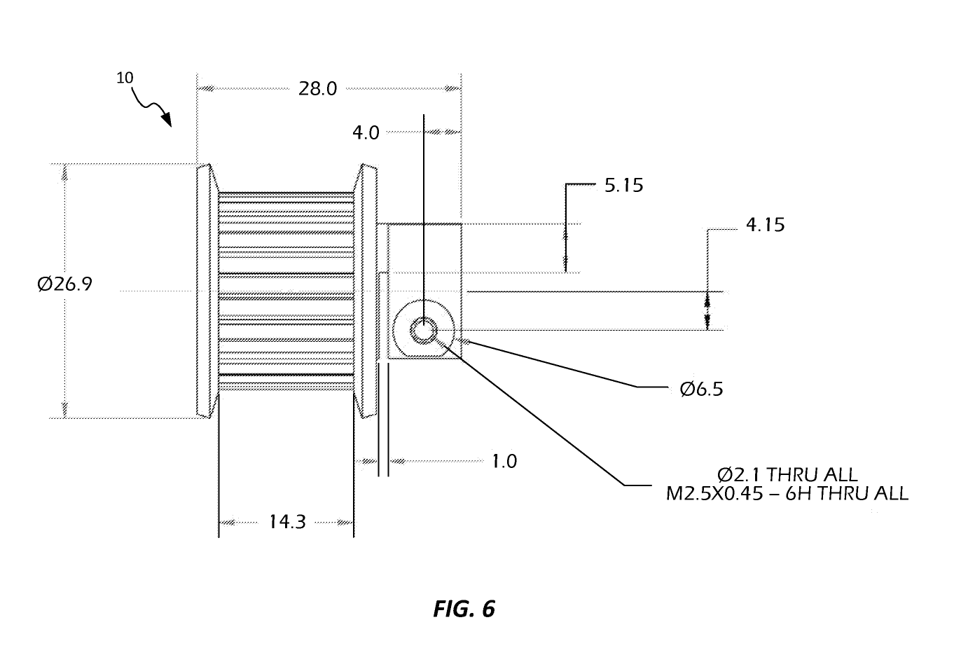

FIG. 5 also illustrates a side view of the example hub 10. While FIGS. 4 and 5 highlight the offset cut used to form the first and second collar segments 28 and 30 and the cut through the clamping collar 20 to form the neck 22, FIGS. 4 and 5 also illustrate example dimensions. All dimensions in the figures are in millimeters, and should be understood to be non-limiting, example dimensions for an illustrative embodiment of the contemplated hub 10. FIG. 6 illustrates a “top view” of the example hub 10 and highlights an example of the amount of material cut from the clamping collar 20 to form the neck 22.

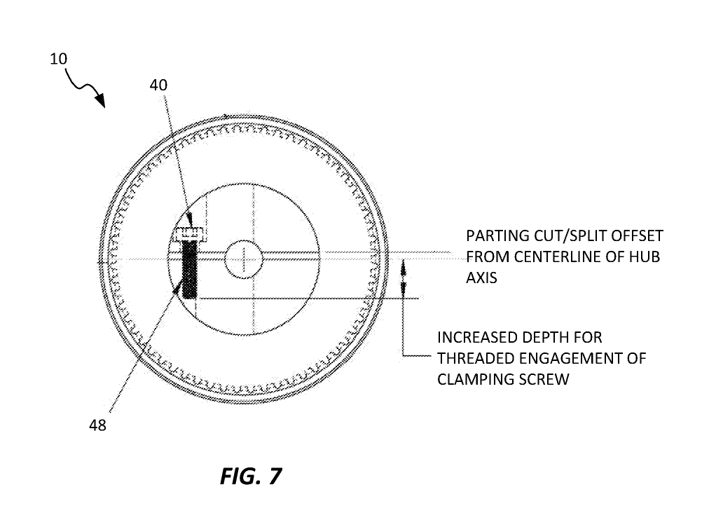

Use of the offset parting cut to form the first and second collar segments 28 and 30 provides advantages across an essentially endless variety of hub sizes and configurations. For example, FIG. 7 illustrates a hub 10 configured as a gear or sprocket. Offsetting the cut between the first and second collar segments 28 and 30 above the center line towards the first collar segment 28 provides increased depth for the clamping screw 40 in the second collar segment 30 and allows for a longer threaded portion 48 of the clamping screw 40 to engage the threaded bore 42.

Notably, modifications and other embodiments of the disclosed invention(s) will come to mind to one skilled in the art having the benefit of the teachings presented in the foregoing descriptions and the associated drawings. Therefore, it is to be understood that the invention(s) is/rare not to be limited to the specific embodiments disclosed and that modifications and other embodiments are intended to be included within the scope of this disclosure. Although specific terms may be employed herein, they are used in a generic and descriptive sense only and not for purposes of limitation.

1. A clamping hub, comprising:
a body;
a clamping collar connected to the body via a neck and extending outward from the body; and
a central bore running through the body and clamping collar and configured for receiving a shaft;
said clamping collar configured to substantially surround and clamp to the shaft and being divided into first and second collar segments along a chord of the central bore that is offset from the center of the central bore towards the first collar segment;
said second collar segment being tapped for a clamping screw that passes through the first collar segment and threadedly engages the second collar segment.

2. The clamping hub of claim 1, wherein the first and second collar segments are separated by a defined gap extending along a longitudinal axis of the central bore to the neck.

3. The clamping hub of claim 1, wherein the first collar segment includes a non-threaded hole aligned with a threaded hole in the second collar segment, for insertion of the clamping screw through the non-threaded hole in the first collar segment and corresponding threaded engagement in the threaded hole of the second collar segment.

4. The clamping hub of claim 1, wherein the neck is formed by a cut or gap at a base of the clamping collar where the clamping collar joins with the body, where the cut or gap runs orthogonal to the longitudinal axis of the central bore and has a depth going from the outer diameter of the clamping collar and extending through the central bore.

5. The clamping hub of claim 4, wherein the cut or gap by which the neck is formed leaves the first and second collar segments floating or cantilevered with respect to the body, thereby allowing the first and second collar segments to clamp around the shaft when the first and second collar segments are drawn towards each other via screw action of the clamping screw.
